(19) United States
(12) Patent Application Publication
(10) Pub. No.: US 2006/0132223 A1
(43) Pub. Date: Jun. 22, 2006

(54) Temperature-stable voltage reference circuit

(76) Inventor: Brian J. Cherek, Colorado Springs, CO (US)

Correspondence Address: SAWYER LAW GROUP LLP, P O BOX 51418, PALO ALTO, CA, 94303, US

(21) Appl. No.: 11/021,346

(22) Filed: Dec. 22, 2004

(51) Int. Cl. G05F 1/10

(52) U.S. Cl. 327/538

(57) ABSTRACT

A voltage reference circuit is disclosed. The circuit comprises a PTAT bias generator circuit and a band gap transistor voltage system coupled to the operational amplifier system. The band gap voltage system includes at least one diode-connected CMOS transistor. The advantage of this configuration is that the diode-connected CMOS device allows for a lower output voltage level than a bipolar device, particularly at colder temperatures. This allows for lower overall operating voltage for the device. The present invention provides for the creation of a temperature-stable reference voltage at a supply voltage and/or operating temperature lower than conventional circuits.

### FIELD OF THE INVENTION

The present invention relates generally to integrated circuits and more particularly to circuits for producing reference voltages and reference currents.

### BACKGROUND OF THE INVENTION

It is important to provide a temperature stable voltage for a variety of applications. Temperature-stable voltage references have a multiplicity of applications. Examples of usage could be voltage monitoring circuits, temperature sensing devices, data conversion products (ADCs and DACs), and frequency/time measurement devices. It is very important for certain low voltage applications that require temperature stable devices to operate increasingly at lower voltages. For example, there are many products in the consumer marketplace in which low voltage/low power operation is needed, such as in cell phones, hearing aids, MP3 players, etc.

Accordingly, what is needed is a system and method for providing a stable reference voltage circuit that operates at lower voltages that addresses these issues. The present invention addresses such a need.

### SUMMARY OF THE INVENTION

A voltage reference circuit is disclosed. The voltage reference circuit comprises a PTAT bias generator circuit and a band gap voltage system coupled to the PTAT bias generator circuit. The band gap voltage system includes at least one diode-connected CMOS transistor.

The advantage of this configuration is that the diode-connected CMOS device allows for a lower output voltage level than a bipolar device, particularly at colder temperatures. This allows for lower overall operating voltage for the device.

The present invention provides for the creation of a temperature-stable reference voltage at a supply voltage and/or operating temperature lower than conventional circuits.

### BRIEF DESCRIPTION OF THE DRAWINGS

FIG. 1A illustrates a first embodiment of a conventional bandgap reference circuit for providing a temperature-stable voltage.

FIG. 1B illustrates a second embodiment of a conventional bandgap circuit.

FIG. 2A illustrates a general embodiment of a temperature stable voltage reference circuit in accordance with the present invention.

FIG. 2B illustrates a specific embodiment of a temperature stable voltage reference circuit in accordance with the present invention.

### DETAILED DESCRIPTION

The present invention relates generally to integrated circuits and more particularly to circuits for producing reference voltages and reference currents. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

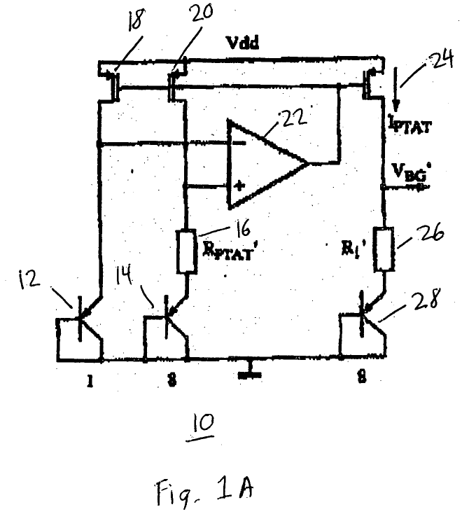

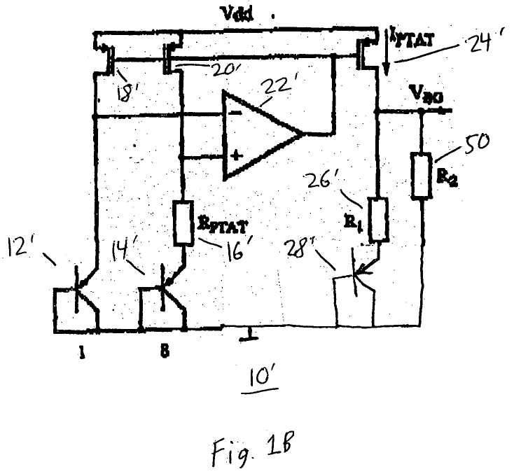

FIG. 1A illustrates a first embodiment of a conventional bandgap reference circuit 10 for providing a temperature-stable voltage. The conventional bandgap reference circuit 10 delivers a voltage of approximately 1.2 V. This is achieved by two vertical PNP transistors 12 and 14 as shown in FIG. 1A with an emitter area ratio of n and equal emitter currents. The difference between their base emitter voltages is in this case proportional to the absolute temperature (PTAT). An operational amplifier 22 controls the emitter currents in such a way that the difference in base-emitter voltages is put across resistor R′_{PTAT} 16. This means that the current through the resistor 16 is also PTAT and so is the current through all transistors in FIG. 1A. The voltage across R′₁ 26 is then also PTAT. The bandgap referred voltage V′_{BG} is formed by adding a base-emitter voltage, which has a negative temperature coefficient, to a voltage across R′₁, 26 which has a positive temperature coefficient.
V′_{BG}=V_{EB}+I_{PTAT}●R′₁

If this V′_{BG} equals the bandgap voltage of silicon (1.2V), a zero temperature coefficient results.

It is clear, however that with a worst-case supply voltage of 0.9 V, a reference voltage of 1.2V cannot be realized.

A second embodiment of a conventional bandgap circuit 10′ is shown in FIG. 1B. Connecting a resistor R₂ 50 across the bandgap reference transistor 28′ leads to

$${V}_{BG} = \frac{{R}_{2}}{{R}_{1} + {R}_{2}} ( {V}_{EB} + {I}_{PTAT} {R}_{1} )$$

The result is a simple resistive division of the conventional bandgap reference voltage of 1.2V. By taking the temperature dependence of the integrated resistors into account, a zero temperature coefficient can be realized.

However, even in this circuit of FIG. 1B, the absolute V_{EB} of the bipolar device 28′ limits the minimum possible output voltage of the circuit, as well as the minimum operating VDD. This is particularly true at colder temperatures, where the absolute V_{EB} of device 28′ increases.

A temperature-stable voltage reference in accordance with the present invention is disclosed that allows for an output voltage lower than the standard 1.2 volt, allowing for low-voltage operation.

The key characteristic of this cell is substitution of a diode-connected bipolar bandgap reference transistor with a diode-connected CMOS bandgap reference transistor. A diode-connected CMOS transistor allows for a voltage with a negative temperature coefficient. However, by using the CMOS transistor, the absolute output voltage and absolute operating VDD can both be reduced, because the CMOS V_{T} can be made lower than the bipolar V_{EB} at a given operating current.

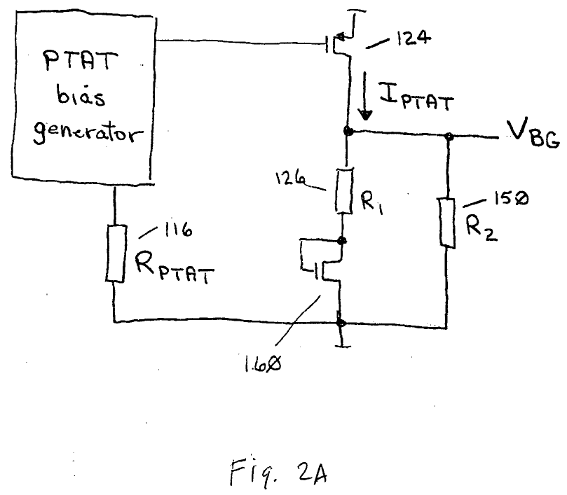

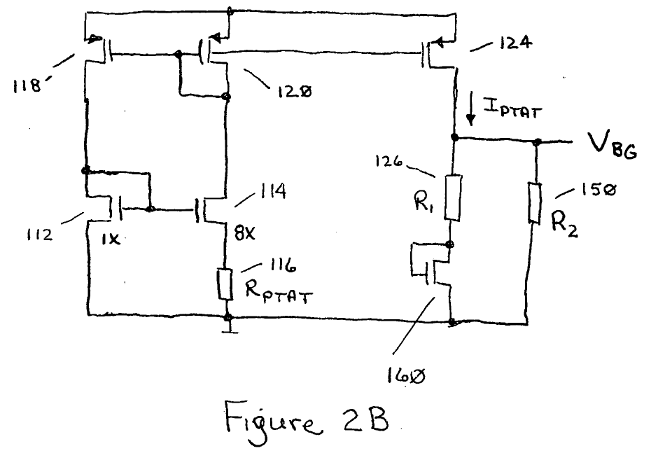

FIG. 2A illustrates a general embodiment of temperature voltage reference circuit 100 in accordance with the present invention. In this embodiment, a PTAT bias generator 102 provides a I_{PTAT} to the output. The key feature of the circuit 100 is that a diode connected CMOS transistor 160 is the bandgap reference transistor rather than the bipolar bandgap reference transistor 28.

FIG. 2B illustrates a more specific embodiment of the circuit 100 in accordance with the present invention. The PTAT bias generator system comprises a first NMOS device, a second NMOS device, ratioed in size to the first, a first resistor, coupled to the second NMOS device, and two PMOS devices, coupled to the first and second NMOS devices, forming a bias generator loop in conjunction with the aforementioned devices. A third PMOS device, coupled to the other two PMOS devices, and ratioed in size to those other devices, to provides a PTAT output current of the bias generator.

The advantage of a circuit in accordance with the present invention is that the diode-connected CMOS device allows for a lower output voltage level than a bipolar device, particularly at colder temperatures. This allows for lower overall operating voltage for the device.

The present invention provides for the creation of a temperature-stable reference voltage at a supply voltage and/or operating temperature lower than conventional circuits.

The present invention can be provided in a conventional CMOS process. Performance would be determined by specific process parameters, particularly threshold voltage and device mobility.

Although the present invention has been described in accordance with the embodiments shown, one of ordinary skill in the art will readily recognize that there could be variations to the embodiments and those variations would be within the spirit and scope of the present invention. For example, although in this embodiment, the bandgap transistor is an NMOS device, it could be replaced with a PMOS device, any and all of the transistors within the circuit could be NMOS devices and they would be within the spirit and scope of the present invention. Accordingly, many modifications may be made by one of ordinary skill in the art without departing from the spirit and scope of the appended claims.

What is claimed is:

1. A voltage reference circuit comprising:
a PTAT bias generator circuit; and
a band gap voltage system coupled to the PTAT bias generator circuit; wherein the band gap voltage system includes at least one diode-connected CMOS transistor.

2. The voltage reference circuit of claim 1 wherein the PTAT bias generator system comprises:
a first NMOS device;
a second NMOS device, ratioed in size to the first NMOS device;
a first resistor, coupled to the second NMOS device;
two PMOS devices, coupled to the first and second NMOS devices, to form a bias generator loop; and
a third PMOS device, coupled to the two PMOS devices, and ratioed in size to those the two PMOS devices, to provide a PTAT output current of the bias generator.

3. The voltage reference circuit of claim 1 wherein a second resistor is coupled to the PTAT bias generator and the diode-connected CMOS transistor.

4. The voltage reference circuit of claim 3 wherein the band gap voltage system includes a third resistor coupled in parallel with the second resistor and the diode-connected CMOS transistor.

5. A voltage reference circuit comprising:
a PTAT bias generator circuit;
a band gap voltage system coupled to the PTAT bias generator circuit; wherein the band gap voltage system includes at least one diode-connected CMOS transistor;
wherein the PTAT bias generator system comprises a first NMOS device; a second NMOS device, ratioed in size to the first NMOS device; a first resistor, coupled to the second NMOS device; two PMOS devices, coupled to the first and second NMOS devices, to form a bias generator loop; and a third PMOS device, coupled to the two PMOS devices, and ratioed in size to those the two PMOS devices, to provide a PTAT output current of the bias generator;
wherein a second resistor is coupled to the PTAT bias generator and the diode-connected CMOS transistor;
wherein the band gap voltage system includes a third resistor coupled in parallel with the second resistor and the diode-connected CMOS transistor.
